(19) United States
(12) Patent Application Publication
(10) Pub. No.: US 2025/0299370 A1
(43) Pub. Date: Sep. 25, 2025

(54) IMAGE PROCESSING DEVICE AND VEHICLE

(71) Applicant: SUBARU CORPORATION, Tokyo (JP)

(72) Inventor: Masahiro SHIRAKI, Tokyo (JP)

(73) Assignee: SUBARU CORPORATION, Tokyo (JP)

(21) Appl. No.: 19/078,816

(22) Filed: Mar. 13, 2025

Related U.S. Application Data
(63) Continuation of application No. PCT/JP2024/011502, filed on Mar. 22, 2024.

(51) Int. Cl. G06T 7/90; G06V 10/56; H04N 1/60

(52) U.S. Cl. CPC G06T 7/90; G06V 10/56; H04N 1/6002; G06V 2201/07

(57) ABSTRACT

An image processing device includes a distance image generation circuit configured to generate a distance image, a grouping process circuit configured to generate grouping information, and an object recognition process circuit configured to perform an object recognition process based on the grouping information. The grouping information is generated by correcting a result of a first grouping process based on a result of a second grouping process. The first grouping process is based on distance information included in the distance image. In the second grouping process, the grouping process is performed such that when a value of a color difference between two pixels of a captured image that are adjacent to each other is equal to or smaller than a predetermined value, the two pixels belong to the same group.

### CROSS-REFERENCE TO RELATED APPLICATIONS

This application is continuation of International Application No. PCT/JP2024/011502, filed on Mar. 22, 2024, the entire contents of which are hereby incorporated by reference.

### BACKGROUND

The disclosure relates to an image processing device that performs object recognition of a subject and a vehicle including the image processing device.

In a vehicle, an object recognition process of a subject is often performed based on a stereo image generated by a stereo camera. An image processing device of the vehicle is configured to perform the object recognition process based on, for example, a result of a grouping process. The image processing device is configured to perform the grouping process based on a distance image obtained based on the stereo image such that when a difference in distance value between two pixels adjacent to each other is equal to or smaller than a predetermined value, the two pixels belong to the same group.

Incidentally, some image processing devices perform a grouping process using a color image. For example, Japanese Unexamined Patent Application Publication (JP-A) No. 2000-67240 discloses a technology of performing region division of a color image by labeling each pixel in the color image based on color.

### SUMMARY

An image processing device according to an embodiment of the disclosure includes a distance image generation circuit, a grouping process circuit, and an object recognition process circuit. The distance image generation circuit is configured to generate a distance image based on a stereo image including a left image and a right image. The grouping process circuit is configured to perform a first grouping process based on distance information included in the distance image. The grouping process circuit is configured to perform a second grouping process based on color information included in a captured image that is one of the left image and the right image. The grouping process circuit is configured to generate grouping information indicating to which group each of multiple pixels in the captured image belongs by performing correction of a processing result of the first grouping process based on a processing result of the second grouping process. The object recognition process circuit is configured to perform an object recognition process based on the grouping information. The grouping process circuit is configured to perform grouping process in the second grouping process such that when a value of a color difference between two pixels adjacent to each other is equal to or smaller than a predetermined value, the two pixels belong to the same group. The grouping process circuit is configured to perform the correction when a first pixel group that has been determined to belong to a first group by the first grouping process includes a second pixel group that has been determined to belong to a second group by the second grouping process and a third pixel group that has been determined to belong to a third group different from the second group by the second grouping process. The grouping process circuit is configured to, by performing the correction, include information indicating that the second pixel group belongs to the second group and information indicating that the third pixel group belongs to the third group in the grouping information about an image region made up of the first pixel group in the captured image.

A vehicle according to another embodiment of the disclosure includes the above-described image processing device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view representing one example of the configuration of a vehicle including a driving assistance device according to an embodiment of the disclosure;

FIG. 2 is a block diagram representing one example of the configuration of the driving assistance device illustrated in FIG. 1;

FIG. 3 is an explanatory view representing one example of a left image and a right image illustrated in FIG. 2;

FIG. 4 is an explanatory view representing CIELab color space;

FIG. 5 is a flowchart representing one example of the operation of the driving assistance device illustrated in FIG. 2;

FIG. 6 is an explanatory view representing one example of the operation of the driving assistance device illustrated in FIG. 2; and

FIG. 7 is another explanatory view representing one example of the operation of the driving assistance device illustrated in FIG. 2.

### DETAILED DESCRIPTION

The accompanying drawings are provided to further understand the disclosure, and are incorporated in this specification and constitute part of this specification. The drawings illustrate an embodiment and play a role in describing the principle of the disclosure along with the specification.

In an image processing device that performs an object recognition process, it is desirable that processing accuracy of the object recognition process be high. Further improvement in the processing accuracy is hoped for.

It is desirable to provide an image processing device and a vehicle that can enhance the processing accuracy of the object recognition process.

In the following, some illustrative embodiments of the disclosure will be described in detail with reference to the accompanying drawings. Note that the following description illustrates one example of the disclosure and is not construed as restricting the disclosure. For example, elements including numerical values, shapes, materials, parts, positions of the parts, connection methods of the parts, etc. are examples and not construed as restricting the disclosure. In the following illustrative embodiment, constituent elements that are not described in the independent claims based on the primary concept of the disclosure are optional and can be provided as necessary. The drawings are schematic and not intended to illustrate to scale. In this specification and the drawings in general, constituent elements that have substantially the same function and substantially the same configuration are denoted by the same reference sign and an overlapping description thereof will be omitted. Constituent elements that are not directly related to the embodiment of the disclosure are not illustrated in the drawings.

### Embodiment

### Example of Configuration

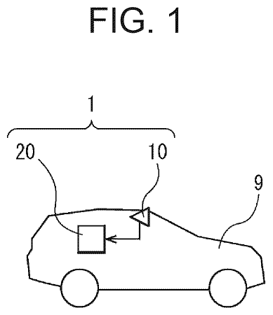

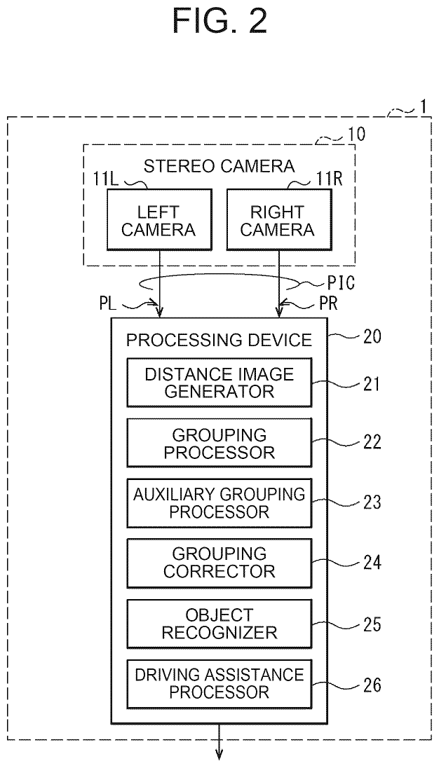

FIGS. 1 and 2 represent one example of the configuration of a driving assistance device 1 including an image processing device according to the embodiment. The driving assistance device 1 is installed in a vehicle 9 and configured to assist driving of the vehicle 9 by a driver who drives the vehicle 9. The driving assistance device 1 includes a stereo camera 10 and a processing device 20.

The stereo camera 10 is configured to generate data of a pair of images with a parallax therebetween by imaging forward of the vehicle 9. In this example, as illustrated in FIG. 1, the stereo camera 10 is disposed inside the vehicle 9, near an upper portion of a windshield of the vehicle 9. The stereo camera 10 has a left camera 11L and a right camera 11R. The left camera 11L and the right camera 11R are disposed spaced a predetermined distance apart in a width direction of the vehicle 9. The left camera 11L and the right camera 11R each include a lens and an image sensor. The left camera 11L generates a left image PL and the right camera 11R generates a right image PR. The left image PL and the right image PR constitute a stereo image PIC.

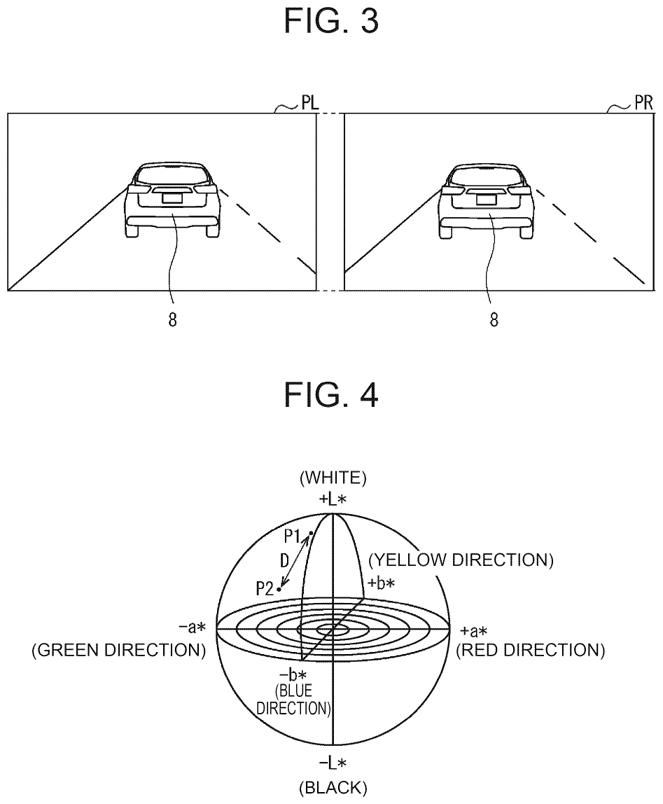

FIG. 3 represents one example of the left image PL and the right image PR constituting the stereo image PIC. In this example, another vehicle (preceding vehicle 8) is traveling in front of the vehicle 9 in a travel lane in which the vehicle 9 is traveling. The left camera 11L generates the left image PL by imaging this preceding vehicle 8, and the right camera 11R generates the right image PR by imaging this preceding vehicle 8. Since the left camera 11L and the right camera 11R are disposed spaced the predetermined distance apart in the width direction of the vehicle 9, the left image PL and the right image PR have a parallax according to this difference between the arrangement positions.

The stereo camera 10 generates a series of stereo images PIC by performing an imaging action at a predetermined frame rate (e.g., 60 [fps]). Then, the stereo camera 10 supplies image data of the series of generated stereo images PIC to the processing device 20.

The processing device 20 is configured to control the operation of the driving assistance device 1 by performing processing based on the left image PL and the right image PR. The processing device 20 is configured using, for example, one or more processors, and one or more memories, and performs processing by executing programs. The processing device 20 has a distance image generator 21, a grouping processor 22, an auxiliary grouping processor 23, a grouping corrector 24, an object recognizer 25, and a driving assistance processor 26.

The distance image generator 21 is configured to generate a distance image by performing a stereo matching process based on the left image PL and the right image PR. For example, the distance image generator 21 determines corresponding points including two image points (a left image point and a right image point) corresponding to each other by performing the stereo matching process based on the left image PL and the right image PR. The left image point is an image point in the left image PL and the right image point is an image point in the right image PR. The distance image generator 21 generates the distance image by calculating a parallax value based on the difference between the position of the left image point and the position of the right image point, and converting this parallax value into a distance value indicating a distance from the stereo camera 10 to the subject.

The grouping processor 22 is configured to perform a grouping process based on distance information on the distance image generated by the distance image generator 21. For example, the grouping processor 22 performs the grouping process such that when a difference in distance value between two pixels adjacent to each other is equal to or smaller than a predetermined value, these two pixels belong to the same group. Thus, in an image region made up of a plurality of pixels belonging to one group, the distance values become almost continuous. The grouping processor 22 performs the grouping process, for example, such that a plurality of pixels corresponding to one subject belongs to one group. For example, when the stereo image PIC includes an image of a plurality of subjects, the grouping processor 22 performs this grouping process on each of these subjects to generate multiple groups corresponding to the respective subjects.

The auxiliary grouping processor 23 is configured to perform a grouping process based on color information on a captured image that is one image of the left image PL and the right image PR. The auxiliary grouping processor 23 performs the grouping process such that when the value of a color difference D between two pixels adjacent to each other is equal to or smaller than a predetermined value, these two pixels belong to the same group. The auxiliary grouping processor 23 calculates the color difference D using, for example, CIELab color space, and performs the grouping process based on this color difference D. CIELab color space is also called L*a*b* color space.

FIG. 4 represents the concept of CIELab color space. CIELab color space is a three-dimensional color space. L* indicates brightness, and a* and b* indicate chromaticity. Here, the chromaticity includes hue and saturation. The direction of +a* indicates a red direction, and the direction of −a* indicates a green direction. The direction of +b* indicates a yellow direction, and the direction of −b* indicates a blue direction.

The auxiliary grouping processor 23 first converts the color space of the captured image that is one image of the left image PL and the right image PR from RGB color space into CIELab color space. The auxiliary grouping processor 23 converts the color space of the captured image, for example, from RGB color space into HSL color space, and then from HSL color space into CIELab color space. That is, in this example, the auxiliary grouping processor 23 converts the color space of the captured image in two steps. However, without being limited thereto, the auxiliary grouping processor 23 may perform the conversion of the color space by any method. As illustrated in FIG. 4, the color difference D between two pixels adjacent to each other is a distance in CIELab color space between a coordinate P1 indicated by color information on a first pixel that is one of these two pixels and a coordinate P2 indicated by color information on a second pixel that is the other of these two pixels. For example, the color difference D is represented by the following formula using a difference Δa* in the a* direction, a difference Δb* in the b* direction, and a difference ΔL* in the L* direction, between the coordinate P1 and the coordinate P2:

$$D = \sqrt{{{{( Δ a \text{*)}}^{2} + ( Δ b \text{*)}}^{2} + ( Δ L \text{*)}}^{2}}$$

When the value of the color difference D between two pixels adjacent to each other is equal to or smaller than a predetermined value, the auxiliary grouping processor 23 performs the grouping process such that these two pixels belong to the same group. Thus, in an image region made up of a plurality of pixels belonging to one group, the values of the color difference D become almost continuous. The auxiliary grouping processor 23 performs the grouping process, for example, such that a plurality of pixels corresponding to one subject belongs to one group. For example, when the captured image includes an image of a plurality of subjects, the auxiliary grouping processor 23 performs this grouping process on each of these subjects to generate multiple groups corresponding to the respective subjects.

The grouping corrector 24 is configured to generate grouping information indicating to which group each of the pixels in the captured image belongs by correcting a processing result of the grouping processor 22 using a processing result of the auxiliary grouping processor 23. As described above, the grouping processor 22 performs the grouping process based on the distance information on the distance image. Thus, as will be described later, for example, when two objects are close to each other, there is a possibility that the grouping processor 22 may determine that these two objects belong to one group. In this case, when the colors of the two objects are different from each other, the auxiliary grouping processor 23 can perform the grouping process such that these two objects belong to different groups from each other. The grouping corrector 24 corrects the processing result of the grouping processor 22 by using, as auxiliary information, the processing result of the auxiliary grouping processor 23 that performs the grouping process based on the color information on the captured image. Thus, in the driving assistance device 1, the accuracy of the grouping process is enhanced.

The object recognizer 25 is configured to perform an object recognition process of recognizing a subject based on the left image PL, the right image PR, the distance image, and the grouping information generated by the auxiliary grouping processor 23.

The driving assistance processor 26 is configured to perform driving assistance of the vehicle 9 based on the processing result of the object recognition process. For example, the driving assistance processor 26 controls the operation of the vehicle 9 so as to notify the driver of the processing result of the object recognition process of the object recognizer 25. In addition, for example, the driving assistance processor 26 performs steering control and braking control of the vehicle 9 based on the processing result of the object recognition process of the object recognizer 25.

Here, the driving assistance device 1 corresponds to one example of “image processing device” in the embodiment of the disclosure. The distance image generator 21 corresponds to one example of “distance image generation circuit” in the embodiment of the disclosure. The grouping processor 22, the auxiliary grouping processor 23, and the grouping corrector 24 correspond to examples of “grouping process circuit” in the embodiment of the disclosure. The grouping process in the grouping processor 22 corresponds to one example of “first grouping process” in the embodiment of the disclosure. The grouping process in the auxiliary grouping processor 23 corresponds to one example of “second grouping process” in the embodiment of the disclosure. The stereo image PIC corresponds to one example of “stereo image” in the embodiment of the disclosure. The left image PL corresponds to one example of “left image” in the embodiment of the disclosure. The right image PR corresponds to one example of “right image” in the embodiment of the disclosure. The color difference D corresponds to one example of “color difference D” in the embodiment of the disclosure. The object recognizer 25 corresponds to one example of “object recognition process circuit” in the embodiment of the disclosure.

### Operation and Effects

Subsequently, the operation and effects of the driving assistance device 1 of the embodiment will be described.

### Overview of Overall Operation

First, the operation of the driving assistance device 1 will be described with reference to FIG. 2. The stereo camera 10 generates the stereo image PIC including the left image PL and the right image PR by imaging forward of the vehicle 9. The processing device 20 performs an object detection process of a subject based on the stereo image PIC, and performs driving assistance of the vehicle 9 based on the processing result of the object detection process.

### Detailed Operation

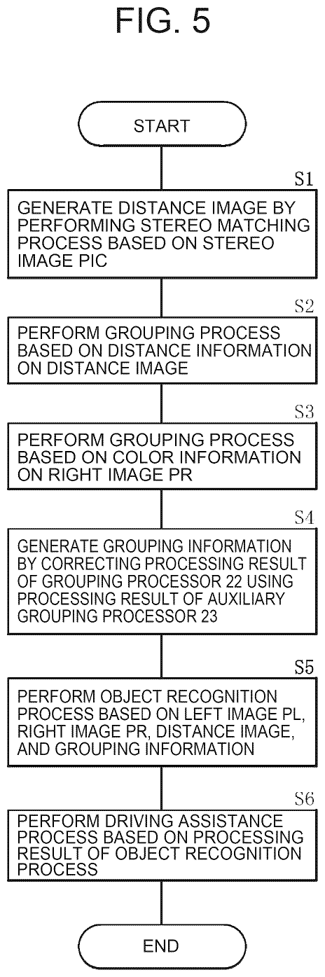

FIG. 5 represents one example of the operation of the driving assistance device 1. The stereo camera 10 generates a series of stereo images PIC by performing the imaging action at the predetermined frame rate. Each time the stereo image PIC is generated, the processing device 20 performs the following process.

First, the distance image generator 21 generates a distance image by performing the stereo matching process based on the left image PL and the right image PR included in the stereo image PIC (step S1).

Next, the grouping processor 22 performs the grouping process based on the distance information on the distance image generated by the distance image generator 21 (step S2). For example, when the difference in distance value between two pixels adjacent to each other is equal to or smaller than the predetermined value, the grouping processor 22 performs the grouping process such that these two pixels belong to the same group.

Next, the auxiliary grouping processor 23 performs the grouping process based on the color information on, in this example, the right image PR (step S3). When the value of the color difference D between two pixels adjacent to each other is equal to or smaller than the predetermined value, the auxiliary grouping processor 23 performs the grouping process such that these two pixels belong to the same group.

Next, the grouping corrector 24 generates grouping information indicating to which group each of the pixels in the captured image belongs by correcting the processing result of the grouping processor 22 obtained in step S2 using the processing result of the auxiliary grouping processor 23 obtained in step S3 (step S4).

Next, the object recognizer 25 performs the object recognition process of recognizing a subject based on the left image PL, the right image PR, the distance image, and the grouping information generated by the auxiliary grouping processor 23 (step S5).

Next, the driving assistance processor 26 performs driving assistance of the vehicle 9 based on the processing result of the object recognition process (step S6). For example, the driving assistance processor 26 controls the operation of the vehicle 9 so as to notify the driver of the processing result of the object recognition process of the object recognizer 25. For example, the driving assistance processor 26 performs the steering control and the braking control of the vehicle 9 based on the processing result of the object recognition process of the object recognizer 25.

Thus ends the process.

Next, the operation of the grouping processor 22, the auxiliary grouping processor 23, and the grouping corrector 24 will be described in detail by taking one example.

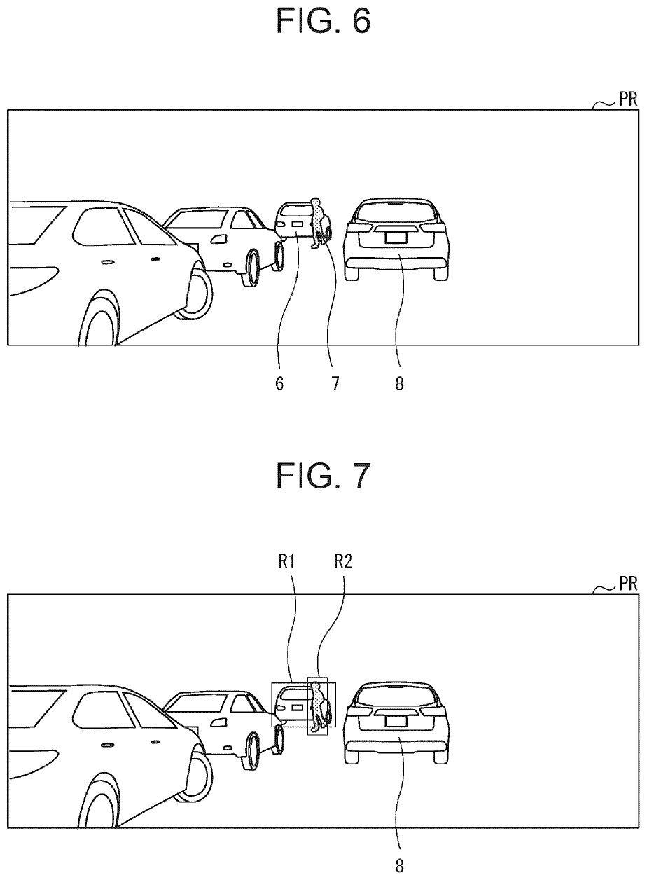

FIGS. 6 and 7 represent one example of the right image PR. The preceding vehicle 8 is traveling forward of the vehicle 9. A plurality of vehicles is parked on a left side of a travel lane in which the vehicle 9 is traveling. A person 7 is walking immediately behind one vehicle 6 among these vehicles. In FIGS. 6 and 7, the person 7 is illustrated using hatching.

As illustrated in step S2, the grouping processor 22 performs the grouping process based on the distance information on the distance image generated by the distance image generator 21. In this example, the vehicle 6 and the person 7 are close to each other. Thus, a distance value to the vehicle 6 from the stereo camera 10 of the vehicle 9 and a distance value to the person 7 therefrom are almost equal. In such a case, therefore, since the difference between the distance values is small, the grouping processor 22 can set one group for an image region including the vehicle 6 and the person 7.

Next, as illustrated in step S3, the auxiliary grouping processor 23 performs the grouping process based on the color information on, in this example, the right image PR. In this example, the color of the vehicle 9 and the color of the person are different from each other. Therefore, the auxiliary grouping processor 23 can set two groups corresponding to the vehicle 6 and the person 7 for the image region including the vehicle 6 and the person 7.

Next, as illustrated in step S4, the grouping corrector 24 generates the grouping information by correcting the processing result of the grouping processor 22 using the processing result of the auxiliary grouping processor 23. In this example, in step S2, the grouping processor 22 sets one group for the image region including the vehicle 6 and the person 7 based on the distance information, and in step S3, the auxiliary grouping processor 23 sets two groups for this image region based on the color information. Thus, for the image region including the vehicle 6 and the person 7, two groups are set based on the color information, so that it is expected that two objects are included. Therefore, the grouping corrector 24 sets two groups for this image region by correcting the processing result of the grouping processor 22 using the processing result of the auxiliary grouping processor 23. In this way, the grouping corrector 24 generates the grouping information.

Next, as illustrated in step S5, the object recognizer 25 performs the object recognition process of recognizing a subject based on the left image PL, the right image PR, the distance image, and the grouping information generated by the auxiliary grouping processor 23. As illustrated in FIG. 7, the object recognizer 25 recognizes two objects including the vehicle 6 and the person 7, and sets an image region R1 for the vehicle 6 and an image region R2 for the person 7.

Then, as illustrated in step S6, the driving assistance processor 26 performs driving assistance of the vehicle 9 based on the processing result of the object recognition process.

Thus, the driving assistance device 1 includes the grouping process circuit, and the object recognition process circuit. In one embodiment, the grouping processor 22, the auxiliary grouping processor 23, and the grouping corrector 24 may serve as the grouping process circuit. The grouping process circuit is configured to perform a first grouping process based on the distance information included in the distance image according to the stereo image PIC including the left image PL and the right image PR. The grouping process circuit is configured to perform a second grouping process based on the color information included in the captured image that is one of the left image PL and the right image PR (in this example, the right image PR). The grouping process circuit is configured to correct the processing result of the first grouping process based on the processing result of the second grouping process. In one embodiment, the object recognizer 25 may serve as the object recognition process circuit. The object recognition process circuit is configured to perform the object recognition process based on the corrected processing result of the first grouping process. The grouping process circuit is configured to perform the grouping process in the second grouping process such that when the value of the color difference between two pixels adjacent to each other is equal to or smaller than the predetermined value, the two pixels belong to the same group. Thus, the driving assistance device 1 can perform the grouping process based not only on the distance information but also on the color information. Therefore, for example, even when two objects are close to each other as illustrated in FIG. 6, the driving assistance device 1 can set two groups corresponding to the two respective objects and thereby enhance the processing accuracy of the grouping process. As a result, in the driving assistance device 1, the processing accuracy of the object recognition process can be enhanced.

In the driving assistance device 1, processing is performed based on the distance image according to the stereo image PIC and the captured image that is one of the left image PL and the right image PR included in the stereo image PIC (in this example, the right image PR). Thus, since the distance image and the captured image are both based on the stereo image PIC, these images have the same coordinate system. In the driving assistance device 1, therefore, processing in correcting the processing result of the grouping processor 22 using the processing result of the auxiliary grouping processor 23 can be simplified.

In the driving assistance device 1, the grouping process circuit (the grouping processor 22, the auxiliary grouping processor 23, and the grouping corrector 24) is configured to convert the color space of the captured image from a first color space (e.g., RGB color space) into a second color space (CIELab color space). The grouping process circuit is configured to calculate the color difference based on the captured image in the second color space (CIELab color space). Thus, in the driving assistance device 1, RGB color space can be converted into a color space in which the color difference is easy to calculate, and the color difference can be calculated using the captured image in this color space, so that the color difference can be calculated by a simple method. As a result, in the driving assistance device 1, the processing accuracy of the object recognition process can be effectively enhanced without performing complicated calculations.

In the driving assistance device 1, the second color space is CIELab color space. In the driving assistance device 1, since the color difference can be calculated using CIELab color space, the color difference can be calculated by a simple method. As a result, in the driving assistance device 1, the processing accuracy of the object recognition process can be effectively enhanced without performing complicated calculations.

In the driving assistance device 1, the two pixels include the first pixel and the second pixel, and the color difference is the distance between the first coordinate indicated by the color information on the first pixel in the second color space and the second coordinate indicated by the color information on the second pixel in the second color space. Thus, in the driving assistance device 1, the color difference can be calculated by a simple method. As a result, in the driving assistance device 1, the processing accuracy of the object recognition process can be effectively enhanced without performing complicated calculations.

### Advantages

As has been described above, in the embodiment, the driving assistance device 1 includes the grouping process circuit and the object recognition process circuit that can perform the object recognition process. The grouping process circuit is configured to perform the first grouping process based on the distance information included in the distance image according to the stereo image including the left image and the right image. The grouping process circuit is configured to perform the second grouping process based on the color information included in the captured image that is one of the left image PL and the right image PR. The grouping process circuit is configured to correct the processing result of the first grouping process based on the processing result of the second grouping process. The object recognition process circuit is configured to perform the object recognition process based on the corrected processing result of the first grouping process. The grouping process circuit is configured to perform the grouping process in the second grouping process such that when the value of the color difference between two pixels adjacent to each other is equal to or smaller than the predetermined value, the two pixels belong to the same group. Thus, the processing accuracy of the object recognition process can be enhanced.

In the embodiment, the grouping process circuit is configured to convert the color space of the captured image from the first color space into the second color space. The grouping process circuit is configured to calculate the color difference based on the captured image in the second color space. Thus, the color difference can be calculated by a simple method, so that the processing accuracy of the object recognition process can be effectively enhanced.

In the embodiment, since the second color space is CIELab color space, the color difference can be calculated by a simple method, so that the processing accuracy of the object recognition process can be effectively enhanced.

In the embodiment, the two pixels include the first pixel and the second pixel, and the color difference is the distance between the first coordinate indicated by the color information on the first pixel in the second color space and the second coordinate indicated by the color information on the second pixel in the second color space. Thus, the color difference can be calculated by a simple method, so that the processing accuracy of the object recognition process can be effectively enhanced.

### Modified Examples

In the above-described embodiment, the auxiliary grouping processor 23 calculates the color difference using CIELab color space, but is not limited thereto. Instead of this, the color difference may be calculated using, for example, HSL color space or Lch color space. Also in this case, the auxiliary grouping processor 23 can calculate the color difference by a relatively simple method.

While one example of the embodiment of the disclosure has been described above with reference to the accompanying drawings, the disclosure is in no way restricted to the above-described embodiment. A person skilled in the art would understand that various modifications and changes can be made without departing from the scope defined by the scope of the claims. The disclosure is intended to encompass such various modifications and changes as long as they belong to the scope of the claims and the scope of their equivalents.

For example, in the above-described embodiment, as illustrated in FIG. 5, the auxiliary grouping processor 23 performs the grouping process based on the color information on the right image PR, but is not limited thereto. Instead of this, the grouping process may be performed based on the color information on, for example, the left image PL.

The advantages described in this specification are merely illustrative, and the advantages of the disclosure are not restricted to the advantages described in this specification. Therefore, other advantages may be obtained in relation to the disclosure.

Further, the disclosure can assume the following aspects.
(1) An image processing device includes a grouping process circuit and an object recognition process circuit. The grouping process circuit is configured to perform a first grouping process based on distance information included in a distance image according to a stereo image including a left image and a right image. The grouping process circuit is configured to perform a second grouping process based on color information included in a captured image that is one of the left image and the right image. The grouping process circuit is configured to correct a processing result of the first grouping process based on a processing result of the second grouping process. The object recognition process circuit is configured to perform an object recognition process based on the corrected processing result of the first grouping process. The grouping process circuit is configured to perform grouping process in the second grouping process such that when a value of a color difference between two pixels adjacent to each other is equal to or smaller than a predetermined value, the two pixels belong to the same group.
(2) In the image processing device according to (1) above, the grouping process circuit is configured to convert a color space of the captured image from a first color space into a second color space, and is configured to calculate the color difference based on the captured image in the second color space.
(3) In the image processing device according to (2) above, the second color space is CIELab color space.
(4) In the image processing device according to (2) or (3) above, the two pixels include a first pixel and a second pixel, and the color difference is a distance between a first coordinate indicated by color information on the first pixel in the second color space and a second coordinate indicated by color information on the second pixel in the second color space.

The processing device 20 illustrated in FIG. 2 can be implemented by a circuit including at least one semiconductor integrated circuit, such as at least one processor (e.g., a central processing unit (CPU)), at least one application-specific integrated circuit (ASIC), and/or at least one field-programable gate array (FPGA). The at least one processor can be configured to execute all or some of the various functions in the processing device 20 illustrated in FIG. 2 by retrieving instructions from at least one non-transitory tangible computer-readable medium. Such a medium can assume various forms including, but not limited to, various magnetic media, such as a hard disc, various optical media, such as a CD or a DVD, and various semiconductor memories (i.e., semiconductor circuits), such as a volatile memory or a non-volatile memory. Volatile memories can include a DRAM and an SRAM. Non-volatile memories can include an ROM and an NVRAM. The ASIC is an integrated circuit (IC) specialized so as to execute all or some of the various functions in the processing device 20 illustrated in FIG. 2. The FPGA is an integrated circuit designed to be configurable after manufacturing so as to execute all or some of the various functions in the processing device 20 illustrated in FIG. 2.

What is claimed is:

1. An image processing device comprising:
a distance image generation circuit configured to generate a distance image based on a stereo image comprising a left image and a right image;
a grouping process circuit configured to perform a first grouping process based on distance information comprised in the distance image; configured to perform a second grouping process based on color information comprised in a captured image that is one of the left image and the right image; and configured to generate grouping information indicating to which group each of multiple pixels in the captured image belongs by performing correction of a processing result of the first grouping process based on a processing result of the second grouping process; and
an object recognition process circuit configured to perform an object recognition process based on the grouping information, wherein the grouping process circuit is:
configured to perform grouping process in the second grouping process such that when a value of a color difference between two pixels adjacent to each other is equal to or smaller than a predetermined value, the two pixels belong to the same group;
configured to perform the correction when a first pixel group that has been determined to belong to a first group by the first grouping process comprises a second pixel group that has been determined to belong to a second group by the second grouping process and a third pixel group that has been determined to belong to a third group different from the second group by the second grouping process; and
configured to, by performing the correction, comprise information indicating that the second pixel group belongs to the second group and information indicating that the third pixel group belongs to the third group in the grouping information about an image region made up of the first pixel group in the captured image.

2. The image processing device according to claim 1, wherein the grouping process circuit is configured to convert a color space of the captured image from a first color space into a second color space, and is configured to calculate the color difference based on the captured image in the second color space.

3. The image processing device according to claim 2, wherein the second color space is CIELab color space.

4. The image processing device according to claim 2, wherein:
the two pixels comprise a first pixel and a second pixel; and
the color difference is a distance between a first coordinate indicated by color information on the first pixel in the second color space and a second coordinate indicated by color information on the second pixel in the second color space.

5. The image processing device according to claim 3, wherein:
the two pixels comprise a first pixel and a second pixel; and
the color difference is a distance between a first coordinate indicated by color information on the first pixel in the second color space and a second coordinate indicated by color information on the second pixel in the second color space.

6. A vehicle comprising the image processing device according to claim 1.
